(19) United States
(12) Patent Application Publication
(10) Pub. No.: US 2026/0137074 A1
(43) Pub. Date: May 21, 2026

(54) Hunting Game Call Device

(71) Applicant: John Pahrmann, Poulsbo, WA (US)

(72) Inventor: John Pahrmann, Poulsbo, WA (US)

(21) Appl. No.: 18/951,979

(22) Filed: Nov. 19, 2024

(51) Int. Cl. A01M 31/00

(52) U.S. Cl. CPC A01M 31/004

(57) ABSTRACT

A game call device that makes generation of a wide variety of game sounds easier. In an embodiment, the game call device is in the form of a bugle or horn having a narrow mouthpiece opening and a plurality of resonating chambers, wherein the narrow mouthpiece opening reduces the air volume required to make authentic game calls and the resonating chambers are tuned to provide accentuate low-pitched, medium-pitched, and high-pitched sounds, depending on the game being hunted. Further, the game call device can be configured for hands-free use by strapping a portion of the device under the arm or on the back, leaving both hands free to manipulate hunting equipment and re-directing the game call away from the hunter which increases safety while hunting large game.

### CROSS-REFERENCE TO RELATED APPLICATIONS

The following patent applications are expressly incorporated herein by reference in their entireties:

none

### BACKGROUND

### Field of the Art

The present invention is in the field of hunting, and more particularly to devices for making game sounds.

### Discussion of the State of the Art

Hunters have long used game calls to lure game closer during a hunt. Game calls mimic sounds made by the game being pursued, often mating sounds, migratory sounds, and territorial sounds. When hunting predators, game calls often include feeding sounds or distress sounds of other animals to lure in the predatory animals. Game calls can be made by mouth or by a combination of mouth and hands to shape and direct the sound, but are often made using game call devices such as bird game calls, elk bugle tubes, and deer horn rattles. These devices facilitate making the appropriate sounds, but there is still a great deal of skill required to make the sounds accurately, much like playing musical instrument.

Elk sounds are particularly difficult to make accurately. During mating season, bull elk make what is known as a bugle call, a high-pitched, piercing sound that can carry for miles across open terrain. It consists of several parts: a long, drawn-out squeal or scream, followed by a series of grunts and guttural barks. Bull elk will also make other grunts and barks, and cows make high-pitched whistling noises. Both bulls and cows make low, drawn-out moaning sounds. Even with a game call device such as a typical elk bugle tube, hunters struggle to make these sounds with sufficient accuracy to fool the elk into coming closer.

What is needed is a game call device that makes generation of a wide variety of game sounds easier, facilitating accurate reproduction of game sounds to lure game.

### SUMMARY

Accordingly, the inventor has conceived and reduced to practice, a game call device that makes generation of a wide variety of game sounds easier. In an embodiment, the game call device is in the form of a bugle or horn having a narrow mouthpiece opening and an acoustic horn with a plurality of acoustic chambers, wherein the narrow mouthpiece opening reduces the air volume required to make authentic game calls and the acoustic chambers are tuned to provide accentuate low-pitched, medium-pitched, and high-pitched sounds, depending on the game being hunted. Further, the game call device can be configured for hands-free use by strapping a portion of the device under the arm or on the back, leaving both hands free to manipulate hunting equipment and re-directing the game call away from the hunter which increases safety while hunting large game.

### BRIEF DESCRIPTION OF THE DRAWING FIGURES

FIG. 1 is an orthographic exploded view of an exemplary game call device with two exemplary blow pipe configurations.

FIG. 2 is an orthographic front view of an exemplary acoustic horn for a game call device.

FIG. 3 is an orthographic front view of an exemplary blow tube for a game call device.

FIG. 4 is an orthographic front view of an alternate exemplary blow tube for a game call device.

FIG. 5 is an orthographic rear view of an exemplary acoustic horn for a game call device.

FIG. 6 is an orthographic rear view of an alternate exemplary acoustic horn for a game call device.

FIG. 7 is a side elevation view of an exemplary embodiment of a game call device.

FIG. 8 is a side elevation view of an exemplary embodiment of a game call device showing air and sound movement within the device.

FIG. 9 is a side elevation view of an alternate exemplary embodiment of a game call device.

FIG. 10 is a side elevation view of an alternate exemplary embodiment of a game call device showing air and sound movement within the device.

FIG. 11 (PRIOR ART) is a side elevation view of an existing elk bugle.

### DETAILED DESCRIPTION

The inventor has conceived, and reduced to practice, a game call device that makes generation of a wide variety of game sounds easier. In an embodiment, the game call device is in the form of a bugle or horn having a narrow mouthpiece opening and a plurality of acoustic chambers, wherein the narrow mouthpiece opening reduces the air volume required to make authentic game calls and the acoustic chambers are tuned to provide accentuate low-pitched, medium-pitched, and high-pitched sounds, depending on the game being hunted. Further, the game call device can be configured for hands-free use by strapping a portion of the device under the arm or on the back, leaving both hands free to manipulate hunting equipment and re-directing the game call away from the hunter which increases safety while hunting large game.

Hunters have long used game calls to lure game closer during a hunt. Game calls mimic sounds made by the game being pursued, often mating sounds, migratory sounds, and territorial sounds. When hunting predators, game calls often include feeding sounds or distress sounds of other animals to lure in the predatory animals. Game calls can be made by mouth or by a combination of mouth and hands to shape and direct the sound, but are often made using game call devices such as bird game calls, elk bugle tubes, and deer horn rattles. These devices facilitate making the appropriate sounds, but there is still a great deal of skill required to make the sounds accurately, much like playing musical instrument.

Elk sounds are particularly difficult to make accurately. During mating season, bull (male) elk make what is known as an elk bugle call, a high-pitched, piercing sound that can carry for miles across open terrain. It consists of several parts: a long, drawn-out squeal or scream, followed by a series of grunts and guttural barks. Bull elk will also make other grunts and barks, and cows make high-pitched whistling noises. Both bulls and cows make low, drawn-out moaning sounds. Even with a game call device such as a typical elk bugle tube, hunters struggle to make these sounds with sufficient accuracy to fool the elk into coming closer.

Elk make a variety of vocalizations during the mating season, which typically runs from September through October in North America. The most distinctive sound is the loud elk bugle call made by mature bull elk. The elk bugle call is a high-pitched, piercing sound that can carry for miles across open terrain. It consists of several parts: a long, drawn-out squeal or scream, followed by a series of grunts and guttural barks. The primary frequency of the squeal or scream portion is known as G0 (gee zero) and averages a frequency of 1426 Hz. The primary frequency of the series of grunts and guttural barks is known as F0 (eff zero) is averages a frequency of 145 Hz. Since these are average frequencies, the actual frequencies produced by a bull elk may vary, so a game call device might be tuned to within a certain percentage of those frequencies (e.g., plus or minus 10%).

However, the anatomy of the elk allows it to make both sounds at the same time, producing a complex harmonic structure combining a high-pitched squeal and a separate, independently-produced a low-pitched rumble. Imitating this dual-frequency sound with a game call is difficult. The bugle serves two primary purposes for the bull elk: 1) advertising his presence and dominance to other males in the area, challenging rival bulls and warning them away from the bull's breeding territory; and 2) attracting female elk (cows) to the bull's harem, signalling to nearby cows that the bull is ready and able to mate.

In addition to the bugle, elk also make other vocalizations during the rut. Bulls will make shorter, lower-pitched grunts and barks, often in response to other elk calls. Cows will make high-pitched whistling sounds, especially when approaching a bull they are interested in mating with. Both bulls and cows make low, drawn-out moaning sounds, likely to communicate within their social group.

The intensity and frequency of these vocalizations peaks during the height of the rut, when competition for mates is greatest. The haunting bugle calls of bull elk are an iconic sound of the autumn woods during elk mating season. However, reproducing these calls are very difficult. Drawbacks to existing elk bugle tubes include requiring a high volume of air to produce high pitches, especially at a volume required to attract elk from long distances and an inability to properly facilitate the entire range of sounds that occur within the bull elk's mating bugle. The game call device described herein provides a solution to these problems through the various features described herein including, but not limited to, a narrow mouthpiece opening and one or more acoustic chambers, wherein the narrow mouthpiece opening reduces the air volume required to make authentic game calls and the one or more acoustic chambers are configured to facilitate production of low-pitched, medium-pitched, and high-pitched sounds, depending on the game being hunted.

When hunting bull elk, the hunter emulates the sound of a bull elk bugle call. This challenges any bull elk in the area to a fight for dominance in that area. When the bull elk comes in sight of the hunter, the hunter emulates the sound of a bark from the bull elk bugle call, causing the bull elk to freeze, expecting a challenge from a rival. At this point the hunter shoots (whether with a rifle or bow). This aspect of hunting elk is quite dangerous, as the elk is usually within charging distance of the hunter. A charge by an elk can injure or kill a hunter. Thus, another aspect of the game call device described herein is the ability of the game call device to be strapped to the hunter's shoulder or back, allowing for hands-free use of the game calling device.

The game call device described herein uses the sounds of the bull elk's bugle to describe the features and operation of the game call device because the bull elk's bugle is particularly complex, requiring a range of sounds from a long, high-pitched squeal to a series of low, guttural barks and grunts. However, the game call device described herein is not limited to game calls for elk, and can be tuned to create game calls for a variety of game animals by adjusting its various features including, but not limited to, the size of the mouthpiece opening, the length of the blow pipe, and the size and shape of the acoustic chambers.

Game calls of this type can be classified as a type of horn. Horns generally have a mouthpiece with an opening, a tube that acts as a resonating chamber, and a bell or other opening which shapes and directs the sound coming out of the horn. Horns typically have a single resonating chamber. Existing elk bulges and similar devices do not have resonating chambers, and are essentially acoustic horns.

A small opening (aperture) in a horn's mouthpiece significantly affects the sound production in several key ways. A smaller opening creates more back pressure (resistance) when playing. This increased resistance gives the player more control over the sound. It requires less air volume but more focused air pressure to produce sound. A smaller opening generally produces a brighter, more focused tone, enhancing the higher frequencies and overtones. This results in a more brilliant or piercing quality, and is particularly helpful in imitating high sounds like the initial scream or squeal of the bull elk's bugle. A smaller opening allows for better control of soft dynamics since less air is needed. A major problem with existing elk bugle game call devices is that they require too much air volume for hunters to comfortably make the required sounds.

Resonating chambers are the second major component of a horn's sound. Resonating chambers are tubes or pipes tuned to a particular frequency primarily due to matching the length of the tube with the wavelength of the frequency to be favored. This frequency is known as the fundamental frequency of the resonating chamber, and is the lowest resonating frequency that the chamber can produce. Resonating chambers can produce any higher harmonic of the fundamental frequency to which the resonating chamber is tuned (e.g., thirds, fifths, octaves, etc.). Resonating chambers will still pass through non-harmonic frequencies introduced at the mouthpiece, but will not amplify them as with harmonic frequencies of the fundamental frequency. Consider, for example, a standard military bugle tuned to C2 (65 Hz) on a piano. It can play G4 (392 Hz). C5 (523 Hz), E5 (659 Hz), and G5 (784 Hz), with other frequencies being possible but less common.

Smaller resonating chambers in a horn favor higher frequencies due to the smaller wavelengths that fit in the chamber, creating a brighter sound with more treble than bass. Because of their higher fundamental resonant frequencies, they respond more quickly to changes in air pressure, which is helpful in imitating high sounds like the initial scream or squeal of the bull elk's bugle which can sometimes have fluctuations in the pitch. Larger resonating chambers in a horn favor lower frequencies due to longer wavelengths fitting in the chamber. They produce stronger fundamental tones, creating a fuller, richer bass response. Larger resonating chambers are generally capable of producing a greater overall volume of sound. The characteristics of larger resonating chambers are beneficial in producing lower sounds such as the gutteral barks and grunts of the bull elk's bugle.

A combination of multiple resonating chambers with different chamber characteristics can be used to achieve a balance of characteristics (e.g., tuning a horn to the range of sounds found in a particular game animal's mating calls). Each resonating chamber has a specific resonant frequency, determined by the size and shape of the chamber. When air vibrates inside the horn, it interacts with these different resonating chambers, amplifying certain frequency components and dampening others. The interaction between the vibrating air and the resonating chambers creates a complex interplay of constructive and destructive interference. This results in the reinforcement of some frequencies and the attenuation of others, ultimately shaping the overall timbre and character of the horn's sound.

The number, size, and arrangement of the resonating chambers can be carefully designed to achieve specific tonal qualities. For example, adding extra chambers can broaden the horn's frequency range, allowing it to produce a wider variety of pitches and overtones; varying the size and shape of the chambers can emphasize different harmonic components, resulting in a brighter, darker, or more mellow tone, and strategically placing the chambers can help control the directional projection of the sound, affecting the perceived tonal balance. By manipulating the resonating chambers, horn designers can fine-tune a horn's sound to enable reproduction of animal sounds of diverse species.

When tuning a resonating chamber for a particular frequency, the length of the chamber should be approximately equal to half the wavelength (22) in order to create a standing wave and amplify the sound. The formula for determining the length (L) of a resonating chamber is:

$$L = λ / 2 = c / ( 2 f )$$

Where:
λ (lambda) is the wavelength of the sound
c is the speed of sound
f is the frequency of the sound

The optimal diameter (D) of the chamber ranges from a minimum of 0.022 to 0.082.

The bell of a horn is the third major horn characteristic. A bell is a type of resonating chamber, also known as an acoustic horn or a waveguide. However, instead of being tuned to resonate at a particular frequency, a bell is configured to amplify the sound of some or all frequencies by provide an acoustic impedance match between a sound source and free air. Acoustic horns convert large pressure variations with a small displacement area into a low pressure variation with a large displacement area and vice versa. In simpler terms, a bell increases the surface area across which the horn's frequency can interact with air, amplifying the sound volume of the frequency by increasing the amplitude of the frequency's waveform. Acoustic horns are typically, but not always, conical in shape, and examples of acoustic horns include acoustic megaphones, alpine horns (or alphorns), and horn loudspeakers. Acoustic horns can be of any shape which increases the surface area with which the sound waves can interact with the air (e.g., cylindrical, spherical, and other shapes can be used as acoustic horns, but their acoustic characteristics will differ from conical bells). Bells of musical instruments and public horn loudspeakers often have an exponentially-increasing cross sectional area (exponential cones), which increases volume, but at the expense of uneven frequency response. A bell helps radiation of sound from the horn by creating a more efficient coupling between the vibrating air column and the surrounding air. It directs and focuses the sound in specific directions, and controls the spread pattern of different frequencies. Acoustic horns are not tuned to a fundamental frequency as are resonating chambers, and

amplify all sounds introduced into them, although the shape of the acoustic horn can emphasize some sounds and de-emphasize others. Since higher frequencies tend to project more directionally and lower frequencies tend to project more omni-directionally, a wider bell generally enhances lower frequencies and a narrower bell tends to focus higher frequencies. These characteristics can be helpful in designing game calls to project in certain directions and to enhance the volume of the sound projected.

A combination of multiple acoustic chambers in an acoustic horn can be used to design a game call designed specifically for a particular game animal (e.g., amplifying the range of sounds found in that game animal's mating calls, while minimizing sounds outside of that range). This will make transmission of preferred sounds (i.e., those emulating the sounds a given game animal makes) at high volumes easier while minimizing transmission of non-preferred sounds (i.e., sounds that do not emulate the sounds a given game animal makes).

For calculating the increase in volume of a bell or acoustic horn, the formula for the theoretical gain (G) of a simple conical acoustic horn is:

$$G = 10 {log}_{10} ( {A}_{2} / {A}_{1} ) dB$$

$$Where :$$

$${A}_{1} = throat area ( input )$$

$${A}_{2} = mouth area ( output )$$

While acoustic horns are typically conically-shaped, this formula may be used to calculate a gain (G) of an acoustic horn of any shape (e.g., cylinders, spheres, etc.) having an opening of a first diameter in one end and an opening of a second diameter in the other end.

Considering the above characteristics of horns, an embodiment configured for reproducing the bull elk's bugle, may comprise a small mouthpiece opening, a small first resonating chamber, a large second resonating chamber, and a medium-sized third resonating chamber. The small mouthpiece opening creates more back pressure and air resistance, resulting in a brighter, more focused tone, enhancing higher frequencies and overtones, and requiring less air volume to produce the required frequency. This is beneficial to production of the initial scream or squeal of the bull elk's bugle. The small first resonating chamber favors higher frequencies and produces a more trebly, piercing quality to the sound, also assisting in production of the initial scream or squeal of the bull elk's bugle. The large second resonating chamber enhances lower frequencies and richer overtones, while also amplifying the sound volume of lower frequencies. The medium-sized third resonating chamber balances the frequency response between the extremes, helping to smooth out the transition between the low and high frequencies. It adds provides a more well-rounded, versatile tonal quality, useful in adding subtlety, naturalness, and realism to the sounds produced. Overall, the multi-chambered configuration of this embodiment would case production of the difficult-to-produce high frequencies of the bull elk's initial scream or squeal. It would further produce a sound that is focused and articulate in the high frequencies due to the small mouthpiece, aiding in production of the scream or squeal; produce rich and powerful sounds in the low register thanks to the large second chamber, aiding in producing the subsequent guttural barks and grunts; and add a naturalness and realism to both sets of sounds due to the balancing influence of the medium-sized third chamber.

Another embodiment for reproducing a bull elk's bugle may comprise a small mouthpiece opening and an acoustic horn. The small mouthpiece opening creates more back pressure and air resistance, resulting in a brighter, more focused tone, enhancing higher frequencies and overtones, and requiring less air volume to produce the required frequency. This is beneficial to production of the initial scream or squeal of the bull elk's bugle. The acoustic horn has a larger diameter first chamber (in this embodiment a cylindrical chamber with rounded corners), a neck having a diameter smaller than the diameter of the first chamber, and a second chamber having a diameter larger than the neck (in this case, a spherical chamber with a diameter the same as the diameter of the first chamber). The throat (input) of the acoustic horn of this embodiment is the small opening of the mouthpiece. The sound is amplified by the greater surface area of the first chamber, but back pressure is caused in the first chamber by the narrower neck, which acts as a mouth (output) of the first chamber and the throat) of the second chamber. The back pressure makes production of high-pitched sounds easier by requiring a lesser volume of air to be maintained for the same air pressure at the throat (input) of the first chamber, but reduces the volume a bit because of the smaller opening required at the neck to produce additional back pressure. Finally, the sound passing through the neck is again amplified by the larger surface area of the second chamber, wherein the neck acts as a throat (input) of the second chamber, and an opening at the other end of the second chamber is the mouth (output) of the second chamber. This restores the volume lost at the neck due to the neck having a smaller opening than the diameter of the first acoustic chamber. The second chamber may have a removable ring to change the size of the opening of the mouth (output) of the second chamber. Note that in embodiments with cross-sections other than circular (e.g., square, rectangular, hexagonal, etc.), the term “diameter” may be replaced by the term “diagonal,” as measured between opposite vertices of the non-circular shape.

Another embodiment for reproducing a bull elk's bugle may comprise a blow pipe with small mouthpiece opening, a resonating tube, and an acoustic horn. The small mouthpiece opening creates more back pressure and air resistance, resulting in a brighter, more focused tone, enhancing higher frequencies and overtones, and requiring less air volume to produce the required frequency. This is beneficial to production of the initial scream or squeal of the bull elk's bugle. The resonating tube is tuned to resonate at a typical G0 frequency of a typical bull elk bugle call, assisting in production of the initial scream or squeal of the bull elk's bugle by amplifying sounds produced at the mouthpiece at the G0 frequency. The acoustic horn serves to amplify the frequencies produced at the mouthpiece. The acoustic horn has a larger diameter first chamber (in this embodiment a cylindrical chamber with rounded corners), a neck having a diameter smaller than the diameter of the first chamber, and a second chamber having a diameter larger than the neck (in this case, a spherical chamber with a diameter the same as the diameter of the first chamber). The throat (input) of the acoustic horn of this embodiment is the small opening of the mouthpiece. The sound is amplified by the greater surface area of the first chamber, but back pressure is caused in the first chamber by the narrower neck, which acts as a mouth (output) of the first chamber and the throat) of the second chamber. The back pressure makes production of high-pitched sounds easier by requiring a lesser volume of air to be maintained for the same air pressure at the throat (input) of the first chamber, but reduces the volume a bit because of the smaller opening required at the neck to produce additional back pressure. Finally, the sound passing through the neck is again amplified by the larger surface area of the second chamber, wherein the neck acts as a throat (input) of the second chamber, and an opening at the other end of the second chamber is the mouth (output) of the second chamber. This restores the volume lost at the neck due to the neck having a smaller opening than the diameter of the first acoustic chamber. The second chamber may have a removable ring to change the size of the opening of the mouth (output) of the second chamber. Note that in embodiments with cross-sections other than circular (e.g., square, rectangular, hexagonal, etc.), the term “diameter” may be replaced by the term “diagonal,” as measured between opposite vertices of the non-circular shape.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other docs not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

The skilled person will be aware of a range of possible modifications of the various embodiments described herein. Accordingly, the present invention is defined by the claims and their equivalents.

### Definitions

“Acoustic chamber” as used herein means any structure of a sound-producing device configured to resonate, amplify, shape, or change a sound introduced into the sound-producing device. The phrase “acoustic chamber” as used herein includes, but is not limited to, resonating chambers tuned to resonate at a given frequency and acoustic horns configured to amplify sounds.

“Acoustic horn” (also known as waveguides) as used herein means an acoustic chamber configured to amplify the sound of some or all frequencies by provide an acoustic impedance match between a sound source and free air. Acoustic horns convert large pressure variations with a small displacement area into a low pressure variation with a large displacement area and vice versa. In simpler terms, an acoustic horn increases the surface area across which the horn's frequency can interact with air, amplifying the sound volume of the frequency. Acoustic horns are typically, but not always, conical in shape, and examples of acoustic horns include acoustic megaphones, alpine horns (or alphorns), and horn loudspeakers. Acoustic horns can be of any shape which increases the surface area with which the sound waves can interact with the air (e.g., cylindrical, spherical, and other shapes can be used as acoustic horns, but their acoustic characteristics will differ from conical bells). The bell of a musical horn is a type of acoustic horn.

“Bugle tube” as used herein means a horn-like device for emulating and amplifying an clk bugle call.

“Elk bugle call” as used herein both mean the mating and territorial call of a male (bull) elk comprising a long, drawn-out squeal or scream, followed by a series of grunts and guttural barks.

“Game call” as used herein means, depending on context, either sounds made by game animals, often mating sounds, migratory sounds, and territorial sounds, or the emulation or mimicry of by hunters. When hunting predators, game calls often include feeding sounds or distress sounds of other animals to lure in the predatory animals. Game calls made by hunters can be made by mouth or by a combination of mouth and hands to shape and direct the sound, but are often made using game call devices such as bird game calls, elk bugle tubes, and deer horn rattles.

“Game call device” as used herein means a device used by hunters for making or facilitating game calls.

“Resonating chamber” means a tube or pipe of any cross-sectional shape tuned to resonate at a particular frequency, which is called its fundamental frequency, by matching the length of the tube with the wavelength of the fundamental frequency. The fundamental frequency of the resonating chamber is the lowest resonating frequency that the chamber can produce. Resonating chambers can produce any higher harmonic of the fundamental frequency to which the resonating chamber is tuned (e.g., thirds, fifths, octaves, etc.). Resonating chambers will still pass through non-harmonic frequencies introduced at the mouthpiece, but will not amplify them as with harmonic frequencies of the fundamental frequency.

### Detailed Description of the Drawing Figures

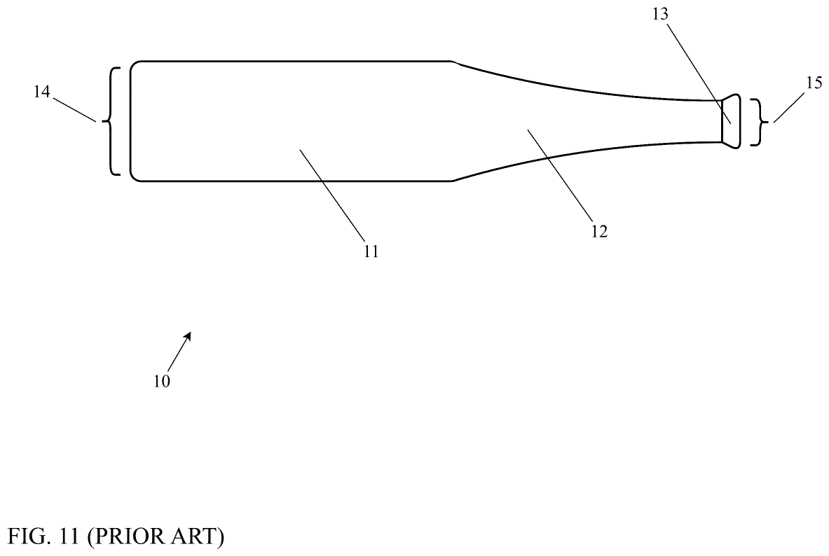

FIG. 11 (PRIOR ART) is a side elevation view of an existing elk bugle tube. Starting first with the prior art, a typical existing elk bugle tube 10 is a simple bat-shaped tube comprising a mouthpiece 13, a conical (or expanding conical) expansion portion 12, and a cylindrical portion 11. The mouthpiece comprises a large opening of 1 inch in diameter or larger, with typical openings being 1.5 inches in diameter. This large opening requires a high volume of air for sound reproduction and amplification by the bugle tube. The expansion portion 12 and cylindrical portion 11 act as an acoustic horn, amplifying sounds made into the bugle tube through the mouthpiece.

The prior art elk bugle tube is used to make elk bugle calls either by using a mouth reed held in the mouth to create vibrations by blowing across it while it is held in the mouth, or by inserting a reed holder (similar to a clarinet's mouthpiece) into the mouthpiece of the elk bugle tube and blowing into the reed holder. The sounds produced by the mouth reed or reed holder are amplified by the elk bugle tube acting as an acoustic horn.

Drawbacks to existing elk bugle tubes include requiring a high volume of air to produce high pitches, especially at a volume required to attract elk from long distances and an inability to properly facilitate the entire range of sounds that occur within the bull elk's mating bugle. The game call device described herein provides a solution to these problems through the various features described herein including, but not limited to, a narrow mouthpiece opening and one or more resonating chambers, wherein the narrow mouthpiece opening reduces the air volume required to make authentic game calls and the one or more resonating chambers are configured to facilitate production of low-pitched, medium-pitched, and high-pitched sounds, depending on the game being hunted.

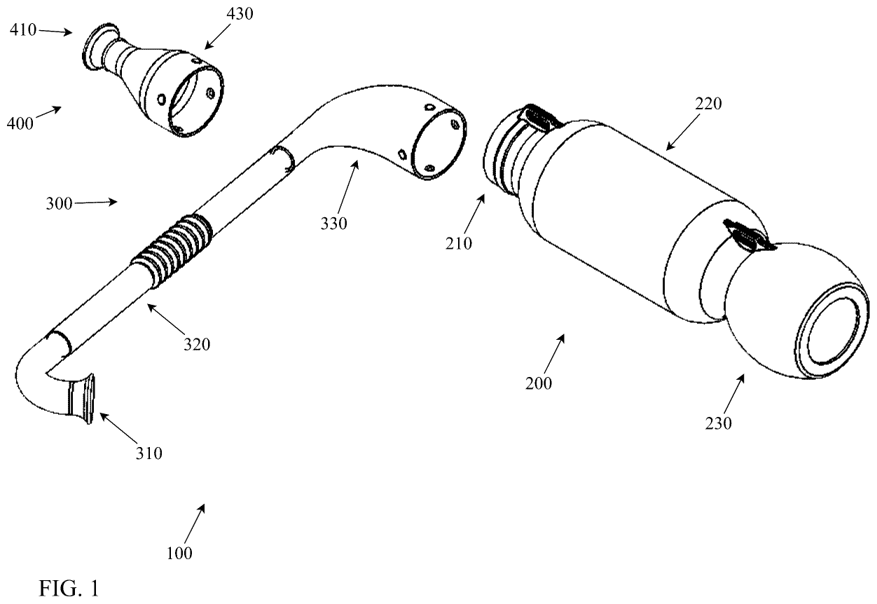

FIG. 1 is an orthographic exploded view of an exemplary game call device with two exemplary blow pipe configurations. The game call device 100 of this embodiment comprises an acoustic horn 200 and one of two blow tubes, either a short blow tube 400 or a long blow tube 300. The acoustic horn 200 of this embodiment comprises female connector 210, a first acoustic chamber 220 and a second acoustic chamber 230. The short blow tube 400 comprises a mouthpiece 410 with an opening (aperture), a neck 420, and a male connector 430. The long blow tube 300 a mouthpiece 310 with an opening (aperture), a resonating tube 320, and a male connector 330. The short blow tube 400 and long blow tube 300 are attachable and removable from the acoustic horn by inserting or removing their male connectors 330, 430 to and from the female connector 210 of the acoustic horn 200.

When used with the small blow tube, the small opening 410 of the mouthpiece 400 creates back pressure and air resistance, resulting in a brighter, more focused tone, enhancing higher frequencies and overtones, and requiring less air volume to produce the required frequency. This is beneficial to production of the initial scream or squeal of the bull elk's bugle. The acoustic horn 200 serves to amplify the frequencies produced at the mouthpiece 400. The acoustic horn has a larger diameter first chamber (in this embodiment a cylindrical chamber with rounded corners), a neck having a diameter smaller than the diameter of the first chamber, and a second chamber having a diameter larger than the neck (in this case, a spherical chamber with a diameter the same as the diameter of the first chamber). The throat (input) of the acoustic horn of this embodiment is the small opening of the mouthpiece. The sound is amplified by the greater surface area of the first chamber, but back pressure is caused in the first chamber by the narrower neck, which acts as a mouth (output) of the first chamber and the throat) of the second chamber. The back pressure makes production of high-pitched sounds easier by requiring a lesser volume of air to be maintained for the same air pressure at the throat (input) of the first chamber, but reduces the volume a bit because of the smaller opening required at the neck to produce additional back pressure. Finally, the sound passing through the neck is again amplified by the larger surface area of the second chamber, wherein the neck acts as a throat (input) of the second chamber, and an opening at the other end of the second chamber is the mouth (output) of the second chamber. This restores the volume lost at the neck due to the neck having a smaller opening than the diameter of the first acoustic chamber. The second chamber may have a removable ring to change the size of the opening of the mouth (output) of the second chamber. Note that in embodiments with cross-sections other than circular (e.g., square, rectangular, hexagonal, etc.), the term “diameter” may be replaced by the term “diagonal,” as measured between opposite vertices of the non-circular shape.

When used with the long blow tube 300, the small opening 310 of the mouthpiece 300 creates back pressure and air resistance, resulting in a brighter, more focused tone, enhancing higher frequencies and overtones, and requiring less air volume to produce the required frequency. This is beneficial to production of the initial scream or squeal of the bull elk's bugle. The blow tube extension 320 of this embodiment may be configured as a small resonating chamber tuned to resonate at a typical G0 frequency (e.g., the average G0 frequency of 1426 Hz) of a typical bull elk bugle call, assisting in production of the initial scream or squeal of the bull elk's bugle by amplifying sounds produced at the mouthpiece at the G0 frequency. As an example, a resonating tube 320 that is 12.03 cm in length will have a fundamental frequency of 1426 Hz, which is the average G0 frequency of a bull elk bugle call. Since this is an average frequency, the actual G0 frequency produced by a bull elk may vary, so a game call device might be tuned to within a certain percentage of that frequency (e.g., plus or minus 10%). The acoustic horn has a larger diameter first chamber (in this embodiment a cylindrical chamber with rounded corners), a neck having a diameter smaller than the diameter of the first chamber, and a second chamber having a diameter larger than the neck (in this case, a spherical chamber with a diameter the same as the diameter of the first chamber). The throat (input) of the acoustic horn of this embodiment is the small opening of the mouthpiece. The sound is amplified by the greater surface area of the first chamber, but back pressure is caused in the first chamber by the narrower neck, which acts as a mouth (output) of the first chamber and the throat) of the second chamber. The back pressure makes production of high-pitched sounds easier by requiring a lesser volume of air to be maintained for the same air pressure at the throat (input) of the first chamber, but reduces the volume a bit because of the smaller opening required at the neck to produce additional back pressure. Finally, the sound passing through the neck is again amplified by the larger surface area of the second chamber, wherein the neck acts as a throat (input) of the second chamber, and an opening at the other end of the second chamber is the mouth (output) of the second chamber. This restores the volume lost at the neck due to the neck having a smaller opening than the diameter of the first acoustic chamber. The second chamber may have a removable ring to change the size of the opening of the mouth (output) of the second chamber. Note that in embodiments with cross-sections other than circular (e.g., square, rectangular, hexagonal, etc.), the term “diameter” may be replaced by the term “diagonal,” as measured between opposite vertices of the non-circular shape.

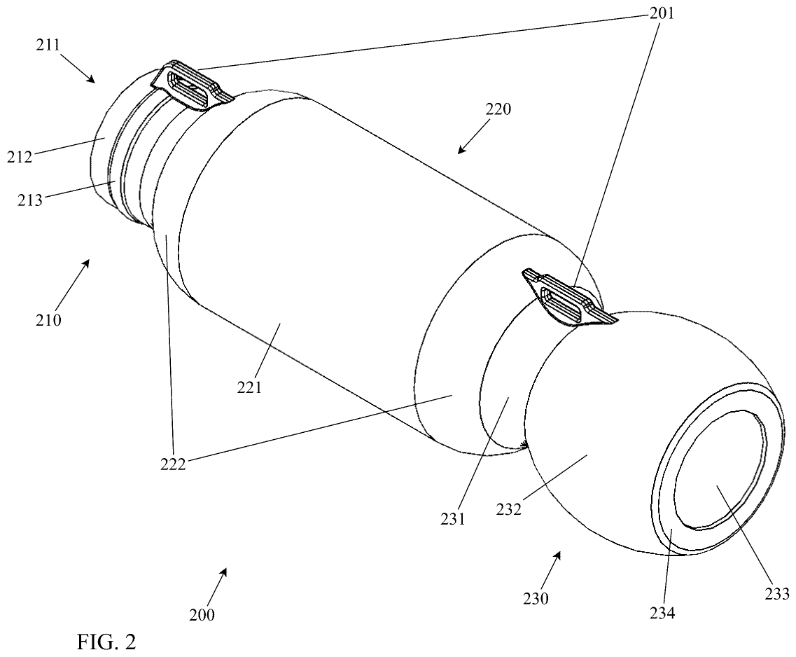

FIG. 2 is an orthographic front view of an exemplary acoustic horn for a game call device. The acoustic horn of this embodiment comprises a female connector 210, a first acoustic chamber, 220, a second acoustic chamber 230, and two strap eyelets 201.

The female connector 210 comprises a connector body 212 having an opening 211 of a diameter sufficient to achieve a good fit with the male connectors 330, 430 of either of the blow tubes 300, 400. The connector body 212 has a projecting ring 213 configured to accept and old locking tabs 333, 433 of either of the blow tubes 300, 400. Note that the male and female connector 0 components could be reversed.

The first acoustic chamber 220 serves to amplify sounds introduced into the game call device at the mouthpiece 310, 410. The first acoustic chamber 220 comprises a chamber body 221, in this case a cylindrical chamber body 221 with rounded ends 222. The first acoustic chamber 220 is configured to amplify the entire range of sounds introduced into the game call device at the mouthpiece 310, 410 of either of the blow tubes.

A neck 231 between the first acoustic chamber 220 and the second acoustic chamber serves to produce additional back pressure in the first acoustic chamber 220, which makes production of high-pitched sounds easier by requiring a lesser volume of air to be maintained for the same air pressure at the throat (input) of the first chamber, but reduces the volume a bit because of the smaller opening required at the neck 231 to produce the additional back pressure in the first acoustic chamber 220.

The second acoustic chamber 230 serves to restore the lost volume caused at the neck 231. The second acoustic chamber comprises the neck 231, a chamber body 232, an opening 233, and a removable ring 234.

When used with the small blow tube, the small opening 410 of the mouthpiece 400 creates back pressure and air resistance, resulting in a brighter, more focused tone, enhancing higher frequencies and overtones, and requiring less air volume to produce the required frequency. This is beneficial to production of the initial scream or squeal of the bull elk's bugle. The acoustic horn 200 serves to amplify the frequencies produced at the mouthpiece 400. The acoustic horn has a larger diameter first chamber 220 (in this embodiment a cylindrical chamber with rounded corners), a neck 231 having a diameter smaller than the diameter of the first chamber 220, and a second chamber 230 having a diameter larger than the neck 231 (in this case, a spherical chamber with a diameter the same as the diameter of the first chamber). The throat (input) of the acoustic horn 200 of this embodiment is the small opening 420 of the mouthpiece. The sound is amplified by the greater surface area of the first chamber 220, but back pressure is caused in the first chamber by the narrower neck 231, which acts as a mouth (output) of the first chamber 220 and the throat (input) of the second chamber 230. The back pressure makes production of high-pitched sounds easier by requiring a lesser volume of air to be maintained for the same air pressure at the throat (input) of the first chamber, but reduces the volume a bit because of the smaller opening required at the neck 231 to produce additional back pressure. Finally, the sound passing through the neck 231 is again amplified by the larger surface area of the second chamber 230, wherein the neck 231 acts as a throat (input) of the second chamber 230, and an opening 233 at the other end of the second chamber 230 is the mouth (output) of the second chamber 230. This restores the volume lost at the neck 231 due to the neck having a smaller opening than the diameter of the first acoustic chamber 220. The second chamber 230 may have a removable ring 234 to change the size of the opening of the mouth (output) of the second chamber 230, again wherein larger openings will produce more volume than smaller openings. Note that in embodiments with cross-sections other than circular (e.g., square, rectangular, hexagonal, etc.), the term “diameter” may be replaced by the term “diagonal,” as measured between opposite vertices of the non-circular shape.

When used with the long blow tube 300, the small opening 310 of the mouthpiece 300

creates back pressure and air resistance, resulting in a brighter, more focused tone, enhancing higher frequencies and overtones, and requiring less air volume to produce the required frequency. This is beneficial to production of the initial scream or squeal of the bull elk's bugle. The blow tube extension 320 of this embodiment may be configured as a small resonating chamber tuned to resonate at a typical G0 frequency (e.g., the average G0 frequency of 1426 Hz) of a typical bull elk bugle call, assisting in production of the initial scream or squeal of the bull elk's bugle by amplifying sounds produced at the mouthpiece at the G0 frequency. As an example, a resonating tube 320 that is 12.03 cm in length will have a fundamental frequency of 1426 Hz, which is the average G0 frequency of a bull elk bugle call. Since this is an average frequency, the actual G0 frequency produced by a bull elk may vary, so a game call device might be tuned to within a certain percentage of that frequency (e.g., plus or minus 10%). The acoustic horn 200 serves to amplify the frequencies produced at the mouthpiece 400. The acoustic horn has a larger diameter first chamber 220 (in this embodiment a cylindrical chamber with rounded corners), a neck 231 having a diameter smaller than the diameter of the first chamber 220, and a second chamber 230 having a diameter larger than the neck 231 (in this case, a spherical chamber with a diameter the same as the diameter of the first chamber). The throat (input) of the acoustic horn 200 of this embodiment is the small opening 420 of the mouthpiece. The sound is amplified by the greater surface area of the first chamber 220, but back pressure is caused in the first chamber by the narrower neck 231, which acts as a mouth (output) of the first chamber 220 and the throat (input) of the second chamber 230. The back pressure makes production of high-pitched sounds easier by requiring a lesser volume of air to be maintained for the same air pressure at the throat (input) of the first chamber, but reduces the volume a bit because of the smaller opening required at the neck 231 to produce additional back pressure. Finally, the sound passing through the neck 231 is again amplified by the larger surface area of the second chamber 230, wherein the neck 231 acts as a throat (input) of the second chamber 230, and an opening 233 at the other end of the second chamber 230 is the mouth (output) of the second chamber 230. This restores the volume lost at the neck 231 due to the neck having a smaller opening than the diameter of the first acoustic chamber 220. The second chamber 230 may have a removable ring 234 to change the size of the opening of the mouth (output) of the second chamber 230, again wherein larger openings will produce more volume than smaller openings. Note that in embodiments with cross-sections other than circular (e.g., square, rectangular, hexagonal, etc.), the term “diameter” may be replaced by the term “diagonal,” as measured between opposite vertices of the non-circular shape.

The strap eyelets 201 allow for insertion of straps such that the game call device 100 can be affixed either to the hunter's arm, shoulder, or back, or to a piece of hunting equipment (e.g., a bow, rifle, backpack, etc.), allowing for hands-free operation of the game call device. This hands-free operation can be of significant benefit allowing the hunter to keep both hands on his or her bow or rifle so as not to miss an opportunity to take a shot when it appears. Further, there are several additional advantages gained when using the game call device with the long blow tube 300. First, the game call device can be used hands-free, as noted above. Second, the hunter can use the game call device with minimal head movement, allowing the hunter to keep his or her eyes on the game animal at all times. Third, the acoustic horn 200 can be placed on the hunter's back, directing sound away from the hunter, making the sound appear to the game animal to be coming from a direction other than where the hunter is. This can be an important safety feature, as blowing a bulge directly at an elk can cause it to charge, endangering the hunter's safety.

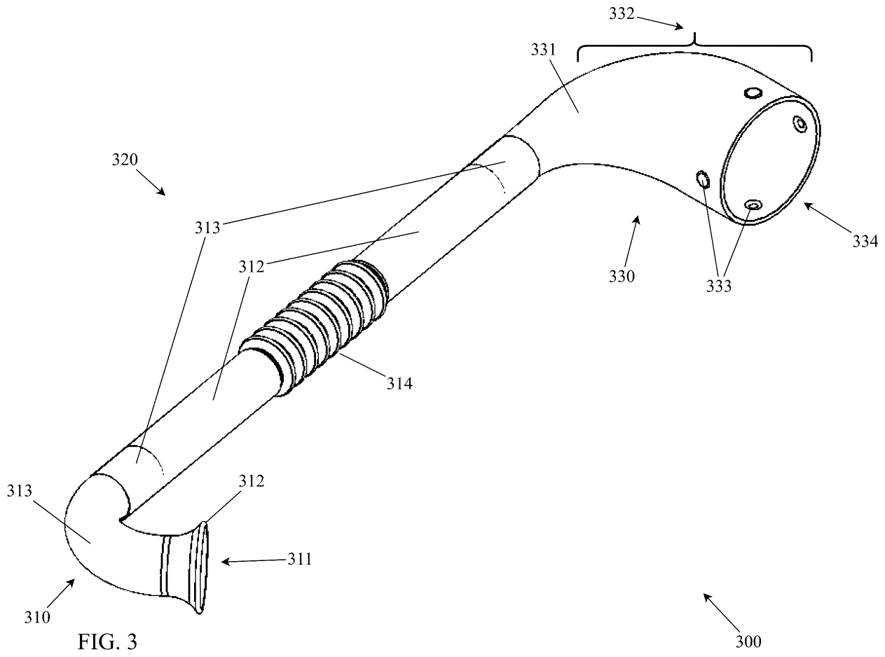

FIG. 3 is an orthographic front view of an exemplary blow tube for a game call device. The long blow tube of this embodiment comprises a mouthpiece 310, a blow tube extension 320, and a male connector 330.

The mouthpiece comprises an opening 311 with a diameter defined by a neck or body 313 of the mouthpiece. The mouthpiece may further have a flared bell or waveguide 312 with a diameter larger than the opening 311 diameter defined by the neck or body 313, the purpose of the flared bell or waveguide 312 being to help direct sounds produced at the hunter's mount into the opening 311. The neck or body 313 of the mouthpiece may be curved to facilitate use of the game call device 100 while it is mounted under the hunter's arm or on the hunter's back using straps inserted through the strap eyelets 201. The small opening 311 of the mouthpiece 300 creates back pressure and air resistance, resulting in a brighter, more focused tone, enhancing higher frequencies and overtones, and requiring less air volume to produce the required frequency. This is beneficial to production of the initial scream or squeal of the bull elk's bugle.

The blow tube extension 320 comprises an extended body 312, optional male/female connectors 313 for disassembling the blow tube extension, and an optional accordion tube portion 314 allowing the hunter to reposition the mouthpiece 310 without repositioning the entire game call device 100. The blow tube extension 320 of this embodiment may be configured as a small resonating chamber tuned to resonate at a typical G0 frequency (e.g., the average G0 frequency of 1426 Hz) of a typical bull elk bugle call, assisting in production of the initial scream or squeal of the bull elk's bugle by amplifying sounds produced at the mouthpiece at the G0 frequency. As an example, a resonating tube 320 that is 12.03 cm in length will have a fundamental frequency of 1426 Hz, which is the average G0 frequency of a bull elk bugle call. Since this is an average frequency, the actual G0 frequency produced by a bull elk may vary, so a game call device might be tuned to within a certain percentage of that frequency (e.g., plus or minus 10%). The acoustic horn 200 serves to amplify the frequencies produced at the mouthpiece 400. In some embodiments, the blow tube extension 320 may be constructed or formed as a single piece instead of multiple connecting pieces.

The male connector 330 comprises a body 331, one or more locking tabs 333, and an opening 334. The body expands in diameter 332 from the diameter of the blow tube extension 320 to the diameter of the female connector 210 of the acoustic horn 200 at the opening 334 of the body. The body of this embodiment is curved along its expanded portion 332 to facilitate placement of the acoustic horn 200 under the hunter's arm or on the hunter's back. The one or more locking tabs 333 are configured to fit into the projecting ring 213 of the acoustic horn to secure the long blow tube 300 to the acoustic horn 200. Note that, because of the expanding portion of the male connector 330, the male connector 330 also acts as an acoustic horn having a throat diameter (input) at location 313 and a mouth diameter (output) at the opening 334. Thus, depending on the configuration of the interface between the blow tube extension and the acoustic horn, the characteristics of the male connector 330 may contribute to the total volume gain of the acoustic horn 200.

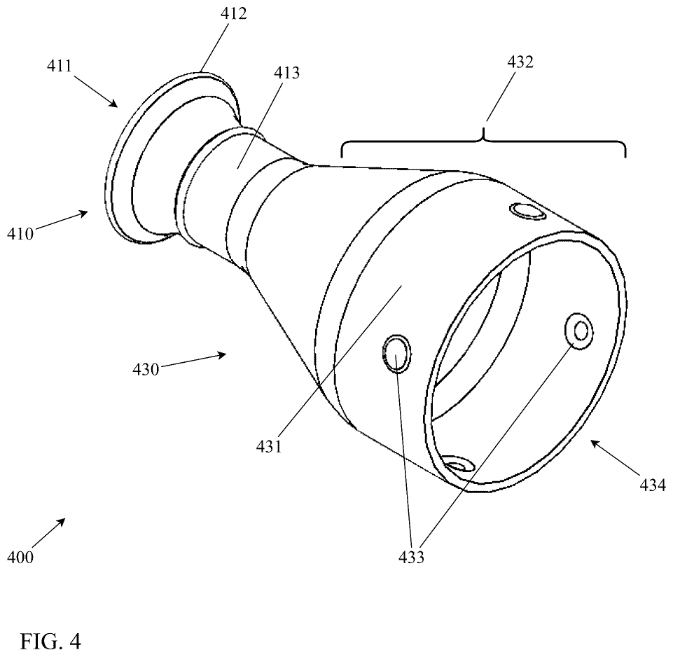

FIG. 4 is an orthographic front view of an alternate exemplary blow tube for a game call device. The small blow tube 400 of this embodiment comprises a mouthpiece 410, a neck, and a male connector 430.

The mouthpiece comprises an opening 411 with a diameter defined by a neck or body 413 of the mouthpiece. The mouthpiece 410 may further have a flared bell or waveguide 412 with a diameter larger than the opening 411 diameter defined by the neck or body 413, the purpose of the flared bell or waveguide 412 being to help direct sounds produced at the hunter's mount into the opening 411. The small opening 411 of the mouthpiece 400 creates back pressure and air resistance, resulting in a brighter, more focused tone, enhancing higher frequencies and overtones, and requiring less air volume to produce the required frequency. This is beneficial to production of the initial scream or squeal of the bull elk's bugle.

The small blow tube of this embodiment does not have a blow tube extension.

The male connector 430 comprises a body 431, one or more locking tabs 433, and an opening 434. The body 430 expands in diameter 432 from the diameter of the neck 413 to the diameter of the female connector 210 of the acoustic horn 200 at the opening 434 of the body. The one or more locking tabs 433 are configured to fit into the projecting ring 213 of the acoustic horn to secure the short blow tube 400 to the acoustic horn 200. Note that, because of the expanding portion of the male connector 430, the male connector 430 also acts as an acoustic horn having a throat diameter (input) at location 413 and a mouth diameter (output) at the opening 434. Thus, depending on the configuration of the interface between the blow tube extension and the acoustic horn, the characteristics of the male connector 430 may contribute to the total volume gain of the acoustic horn 200.

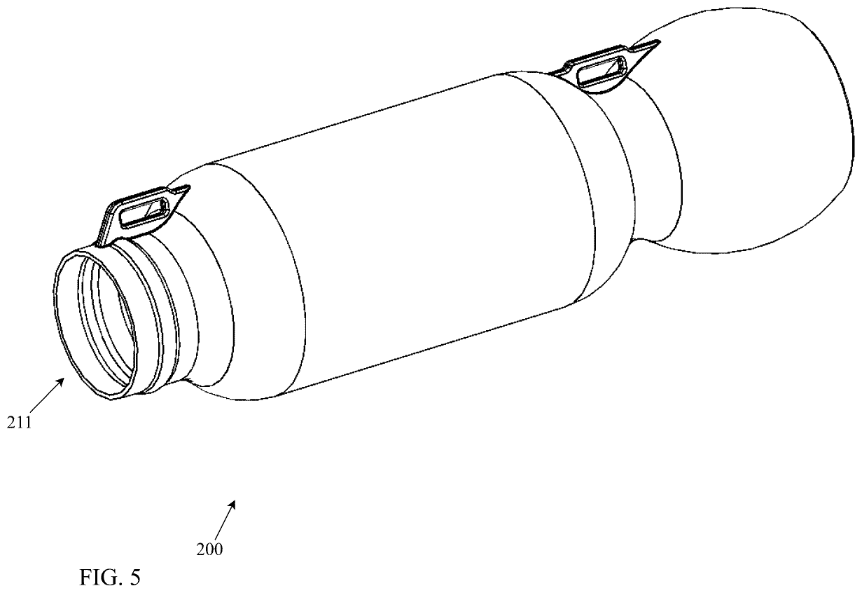

FIG. 5 is an orthographic rear view of an exemplary acoustic horn for a game call device. This drawing shows the front opening 211 of the female connector 210 of the acoustic horn 200 shown in FIG. 2.

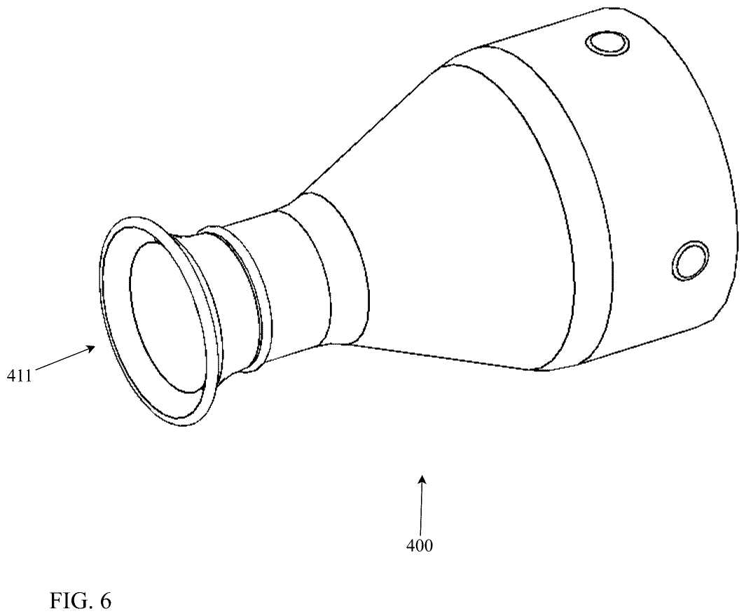

FIG. 6 is an orthographic rear view of an alternate exemplary acoustic horn for a game call device. This drawing shows the mouthpiece opening 411 of the mouthpiece 410 of the small blow tube 400 shown in FIG. 4.

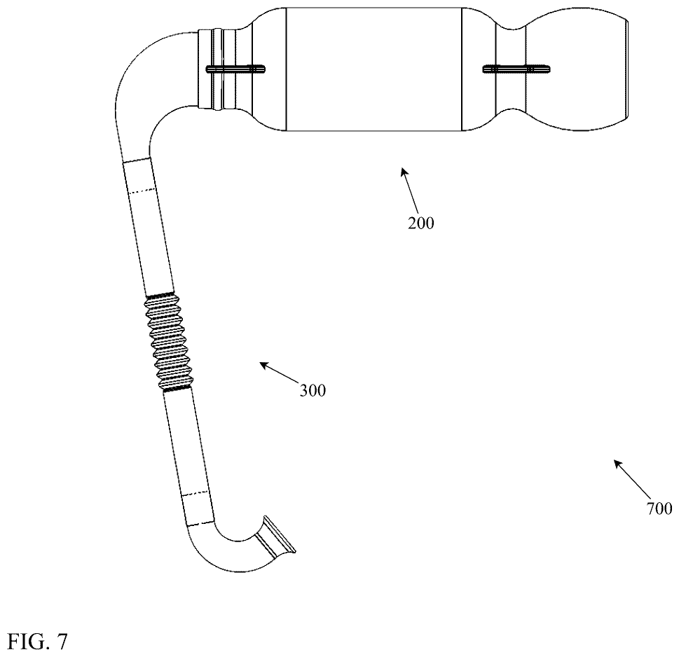

FIG. 7 is a side elevation view of an exemplary embodiment of a game call device. This embodiment 700 shows the long blow tube 300 inserted into the acoustic horn 200 in one use configuration.

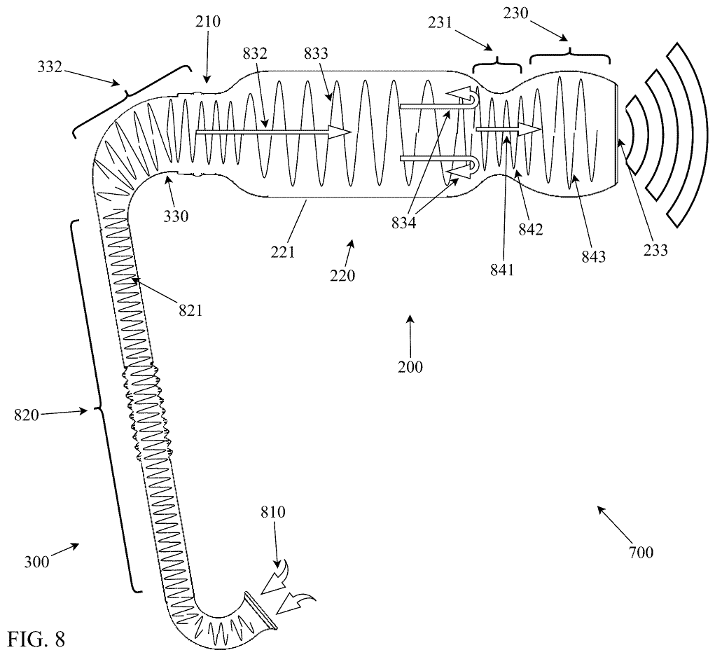

FIG. 8 is a side elevation view of an exemplary embodiment of a game call device showing air and sound movement within the device as configured in the embodiment 700 shown in FIG. 7. Air 810 from the hunter's mouth enters the mouthpiece of the game call device 700 vibrating at a frequency or frequencies generated by the hunter's mouth or by a combination of the hunter's mouth and a mouth reed. The air and sound waves (i.e., air pressure waves) travel along the blow tube extension 300 which in this embodiment is of a length 820 of 12.3 cm, which resonates at 1426 Hz, the average G0 frequency of a bull elk bulge call 821. The sound is first amplified at the expanding portion 332 of the male connector 330. As air passes through 832 the first chamber 220 of the acoustic horn 200, a first portion of the air 834 hits the reduced-diameter portion of the neck 231 and is redirected backward, causing back pressure within the first chamber 220, while a second portion of the air 841 passes through the neck 231 and out the opening 233. The sound waves 833 are amplified a second time by the expansion in diameter of the first chamber 220 from its throat (input) at the female connector 210 to the diameter of the body 221 of the first chamber 220. The amplification of the soundwaves is reduced 842 at the neck 231 of the acoustic horn 200, and re-amplified 843 in the second chamber 230 of the acoustic horn 200.

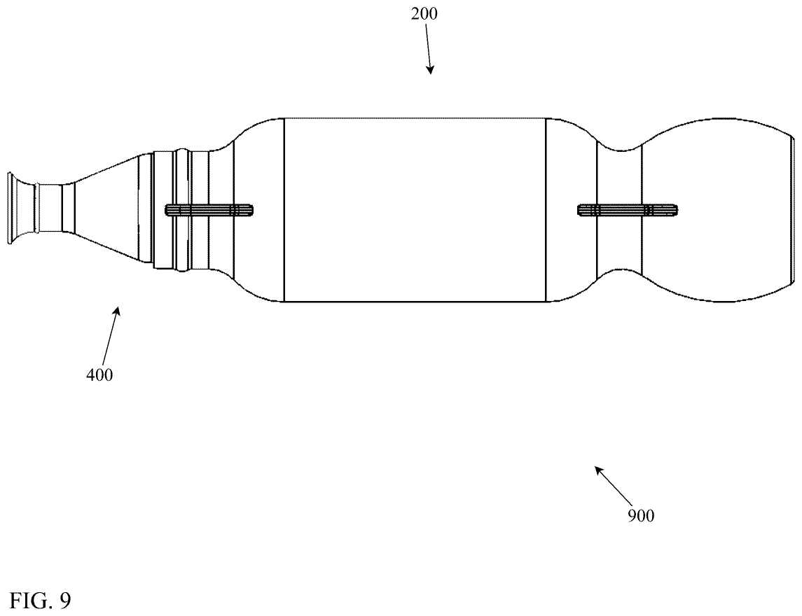

FIG. 9 is a side elevation view of an alternate exemplary embodiment of a game call device. This embodiment 900 shows the short blow tube 400 inserted into the acoustic horn 200 in another usconfiguration.

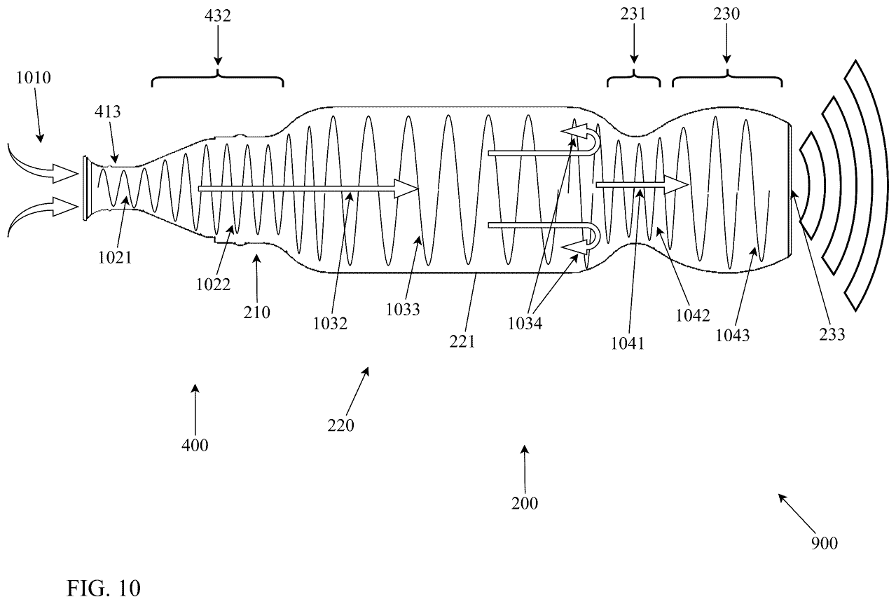

FIG. 10 is a side elevation view of an alternate exemplary embodiment of a game call device showing air and sound movement within the device as configured in the embodiment 900 shown in FIG. 9. Air 1010 from the hunter's mouth enters the mouthpiece of the game call device 900 vibrating at a frequency or frequencies generated by the hunter's mouth or by a combination of the hunter's mouth and a mouth reed. The air and sound waves (i.e., air pressure waves) 1021 travel along the neck 413. The sound is first amplified 1022 at the expanding portion 432 of the male connector 430. As air passes through 1032 the first chamber 220 of the acoustic horn 200, a first portion of the air 1034 hits the reduced-diameter portion of the neck 231 and is redirected backward, causing back pressure within the first chamber 220, while a second portion of the air 1041 passes through the neck 231 and out the opening 233. The sound waves 1033 are amplified a second time by the expansion in diameter of the first chamber 220 from its throat (input) at the female connector 210 to the diameter of the body 221 of the first chamber 220. The amplification of the sound waves is reduced 1042 at the neck 231 of the acoustic horn 200, and re-amplified 1043 in the second chamber 230 of the acoustic horn 200.

What is claimed is:

1. A game call device comprising:
a mouthpiece having a mouthpiece opening of one inch or less in diameter; and
an acoustic horn attached to the mouthpiece comprising:
a first acoustic chamber having a first chamber body diameter larger than the opening of the mouthpiece, the first acoustic chamber having a first chamber throat diameter equal to or larger than the diameter of the mouthpiece opening and a first chamber mouth diameter equal to or larger than the first chamber throat diameter;
a second acoustic chamber having a second chamber body diameter larger than the opening of the mouthpiece, the second acoustic chamber having a second chamber throat diameter equal to the first chamber mouth diameter and a second chamber mouth diameter equal to or larger than the second chamber throat diameter; and
a neck between the first acoustic chamber and the second acoustic chamber, the neck having a neck diameter smaller than both the first chamber body diameter and the second chamber body diameter, the neck comprising an indentation in the exterior perimeter of the acoustic horn which narrows a portion of the acoustic horn between the first chamber and the second acoustic chamber, wherein the neck diameter defines the first chamber mouth diameter and the second chamber throat diameter.

2. The game call device of claim 1, wherein the mouthpiece is removable from the acoustic horn.

3. The game call device of claim 1, wherein the first acoustic chamber is of a roughly cylindrical shape with rounded edges.

4. The game call device of claim 1, wherein the second acoustic chamber is of a roughly spherical shape.

5. The game call device of claim 1, further comprising one or more removable rings, wherein the second chamber mouth diameter is adjustable by removing and replacing the one or more removable rings from the mouth of the second chamber.

6. A game call device comprising:
a mouthpiece having a mouthpiece opening;
a blow tube extension attached to the mouthpiece comprising a resonating chamber tuned to produce a frequency in the range of 1300 Hz to 1500 Hz; and
an acoustic horn attached to the blow tube extension and configured to amplify sounds introduced into the mouthpiece as passed through the resonating chamber, or resonated by the resonating chamber, or both.

7. The game call device of claim 6, wherein the mouthpiece, or blow tube extension, or both, are removable from the acoustic horn.

8. The game call device of claim 6, wherein the acoustic horn is of a roughly cylindrical shape with rounded edges.

9. The game call device of claim 6, further comprising one or more removable rings, wherein the first chamber mouth diameter is adjustable by removing and replacing the one or more removable rings from the mouth of the second chamber.

10. The game call device of claim 6, wherein the acoustic horn is a conical bell.

11. The game call device of claim 6, wherein the acoustic horn is a flared bell.

12. The game call device of claim 6, wherein the resonating chamber is configured to resonate a frequency in the range of plus or minus 3% of the average G0 frequency (1426 Hz) of the initial scream or squeal of the bull elk bugle call.

13. A game call device comprising:
a mouthpiece having a mouthpiece opening of one inch or less in diameter;
a blow tube extension attached to the mouthpiece of sufficient length to allow use of the game call device hands free while an acoustic horn of the device is attached to a portion of a user's body; and
an acoustic horn configured to amplify sounds introduced into the mouthpiece, the acoustic horn comprising:
an acoustic chamber configured to amplify sounds introduced into the mouthpiece; and
one or more eyelets configured for insertion of a strap for attachment of the acoustic horn to the portion of the user's body.

14. The game call device of claim 13, wherein the mouthpiece, or blow tube extension, or both, are removable from the acoustic horn.

15. The game call device of claim 13, wherein the acoustic horn is of a roughly cylindrical shape with rounded edges.

16. The game call device of claim 13, further comprising one or more removable rings, wherein the first chamber mouth diameter is adjustable by removing and replacing the one or more removable rings from the mouth of the second chamber.

17. The game call device of claim 13, wherein the one or more eyelets are positioned to allow for attachment to the user's body under the user's arm.

18. The game call device of claim 13, wherein the one or more eyelets are positioned to allow for attachment to the user's body on the user's back.
